(19) United States
(12) Patent Application Publication
(10) Pub. No.: US 2026/0222498 A1
(43) Pub. Date: Jul. 30, 2026

(54) IMAGE FORMING APPARATUS AND OPERATION CONTROL METHOD THAT EACH MAKE IT POSSIBLE TO PREVENT ABNORMALITY RELATED TO DISABLED OPTIONAL APPARATUS FROM BEING REPORTED AT TIME OF START

(71) Applicant: KYOCERA Document Solutions Inc., Osaka (JP)

(72) Inventor: Masahiro Nakao, Osaka (JP)

(21) Appl. No.: 19/460,933

(22) Filed: Jan. 27, 2026

(30) Foreign Application Priority Data
Jan. 28, 2025 (JP) 2025-011973

(51) Int. Cl. H04N 1/00

(52) U.S. Cl. CPC H04N 1/00087; H04N 1/00037; H04N 2201/0094

(57) ABSTRACT

An image forming apparatus includes a connection portion, a setting processing portion, and a switch processing portion. An optional apparatus is connected to the connection portion. The setting processing portion sets the function of the optional apparatus connected to the connection portion to be disabled. The switch processing portion switches, in a case where an abnormality related to the optional apparatus connected to the connection portion occurs when the image forming apparatus is started, between reporting occurrence of the abnormality and not reporting the occurrence of the abnormality on the basis of whether or not the function of the optional apparatus corresponding to the abnormality is set to be disabled.

### INCORPORATION BY REFERENCE

This application is based upon and claims the benefit of priority from the corresponding Japanese Patent Application No. 2025-011973 filed on January 28, 2025, the entire contents of which are incorporated herein by reference.

### BACKGROUND

This disclosure relates to an image forming apparatus and an operation control method.

An image forming apparatus such as a multifunction peripheral to which an optional apparatus such as a post-processing apparatus is connected has been known. In addition, an image forming apparatus that makes it possible to disable the function of the optional apparatus by disconnecting communication with the optional apparatus has been known.

### SUMMARY

An image forming apparatus according to an aspect of this disclosure includes a connection portion, a setting processing portion, and a switch processing portion. An optional apparatus is connected to the connection portion. The setting processing portion sets the function of the optional apparatus connected to the connection portion to be disabled. The switch processing portion switches, in a case where an abnormality related to the optional apparatus connected to the connection portion occurs when the image forming apparatus is started, between reporting occurrence of the abnormality and not reporting the occurrence of the abnormality on the basis of whether or not the function of the optional apparatus corresponding to the abnormality is set to be disabled.

An operation control method according to another aspect of this disclosure is executed by an image forming apparatus including a connection portion to which an optional apparatus is connected. The operation control method includes a setting step and a switch step. In the setting step, a function of the optional apparatus connected to the connection portion is set to be disabled. In the switch step, in a case where an abnormality related to the optional apparatus connected to the connection portion occurs when the image forming apparatus is started, reporting occurrence of the abnormality and not reporting the occurrence of the abnormality are switched on the basis of whether or not the function of the optional apparatus corresponding to the abnormality is set to be disabled.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming system including an image forming apparatus according to an embodiment of this disclosure.

FIG. 2 is a flowchart showing an example of a report switching process that is executed by the image forming apparatus according to the embodiment of this disclosure.

### DETAILED DESCRIPTION

Hereinafter, an embodiment of this disclosure will be described with reference to the accompanying drawings. It is noted that the following embodiment is a specific example of this disclosure and does not limit the technical scope of this disclosure.

### Configuration of Image Forming System 100

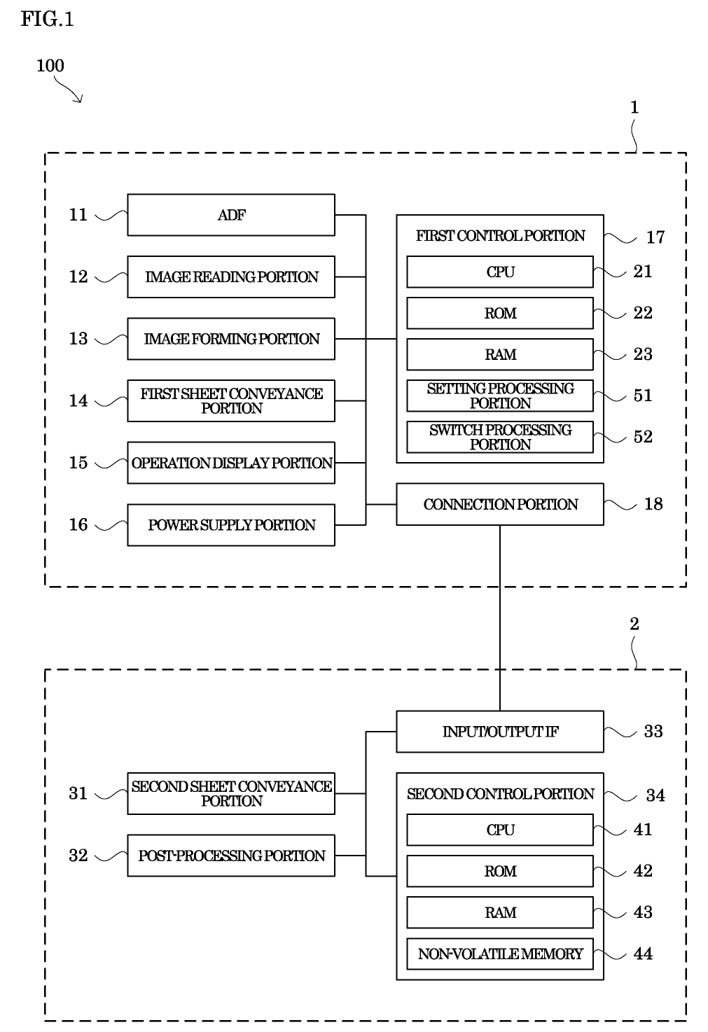

First, the configuration of an image forming system 100 including an image forming apparatus 1 according to the embodiment of this disclosure will be described with reference to FIG. 1. Here, FIG. 1 is a block diagram showing the configuration of the image forming system 100. It is noted that FIG. 1 shows the image forming apparatus 1 and a post-processing apparatus 2 using dashed lines.

It is noted that the following gives description using, as an example, the image forming system 100 in which an optional apparatus that is connected to the image forming apparatus 1 is the post-processing apparatus 2.

As shown in FIG. 1, the image forming system 100 includes the image forming apparatus 1 and the post-processing apparatus 2.

The image forming apparatus 1 is a multifunction peripheral having a plurality of functions such as a facsimile function and a copy function along with a scan function of reading an image on a document sheet and a print function of forming an image on a sheet on the basis of image data. It is noted that the image forming apparatus 1 is not limited to a multifunction peripheral and may be an apparatus such as a printer, a facsimile apparatus, and a copier each having the print function.

The post-processing apparatus 2 executes a post-process defined in advance on a sheet conveyed from the image forming apparatus 1 and on which an image has been formed. Specifically, the post-process includes a staple process of fastening a bunch of sheets together using a staple. The post-processing apparatus 2 is a type of optional apparatus that is connected to the image forming apparatus 1. It is noted that the post-process may include a process different from the staple process such as a punch process of making a punch hole in a sheet.

It is noted that the optional apparatus which is connected to the image forming apparatus 1 is not limited to the post-processing apparatus 2 in the image forming system 100 and may be an additional sheet feed unit or the like.

### Configuration of Image Forming Apparatus 1

Next, the configuration of the image forming apparatus 1 will be described with reference to FIG. 1.

As shown in FIG. 1, the image forming apparatus 1 includes an auto document feeder (ADF) 11, an image reading portion 12, an image forming portion 13, a first sheet conveyance portion 14, an operation display portion 15, a power supply portion 16, a first control portion 17, and a connection portion 18.

The ADF 11 conveys a document sheet an image on which is read by the image reading portion 12. The ADF 11 includes a document sheet set portion, a plurality of conveyance rollers, a document sheet holder, and a sheet discharge tray. It is noted that the ADF 11 may be the optional apparatus.

The image reading portion 12 implements the scan function. The image reading portion 12 includes a document sheet table, a light source, a plurality of mirrors, an optical lens, and a charge coupled device (CCD). The image reading portion 12 reads an image from a document sheet conveyed by the ADF 11 and outputs image data including the read image. In addition, the image reading portion 12 reads an image from a document sheet placed on the document sheet table and outputs image data including the read image.

The image forming portion 13 implements the print function. For example, the image forming portion 13 forms an image on a sheet by electrophotography. The image forming portion 13 includes a plurality of image forming units corresponding to a plurality of printing colors, a laser scanning unit, an intermediate transfer belt, a secondary transfer device, a fixing device, and a sheet discharge tray. The image forming portion 13 forms a color or monochrome image on the basis of image data output from the image reading portion 12. In addition, the image forming portion 13 forms a color or monochrome image on the basis of image data received from an external information processing apparatus. It is noted that the image forming portion 13 may form an image on a sheet in a method such as an inkjet method different from electrophotography.

The first sheet conveyance portion 14 conveys a sheet on which an image is formed by the image forming portion 13. The first sheet conveyance portion 14 includes a sheet feed cassette, a first sheet conveyance path, and a plurality of first conveyance rollers. The image forming portion 13 forms an image on a sheet supplied from the first sheet conveyance portion 14.

The operation display portion 15 is a user interface of the image forming system 100. The operation display portion 15 includes a display portion and an operation portion. The display portion displays various kinds of information in response to a control instruction from the first control portion 17. For example, the display portion is a display device such as a liquid-crystal display. The operation portion inputs various kinds of information to the first control portion 17 in response to an operation of a user. For example, the operation portion is an operation device including an operation key and a touch panel.

The power supply portion 16 supplies power to each of the portions of the image forming apparatus 1. In addition, the power supply portion 16 supplies power to each of the portions of the post-processing apparatus 2 mounted on the image forming apparatus 1. Specifically, the power supply portion 16 includes an AC/DC converter or a DC/DC converter capable of outputting a direct-current voltage having a voltage value defined in advance.

The first control portion 17 integrally controls the image forming system 100. That is, the first control portion 17 controls the image forming apparatus 1 and the post-processing apparatus 2.

As shown in FIG. 1, the first control portion 17 includes a CPU 21, a ROM 22, and a RAM 23. The CPU 21 is a processor that executes various calculation processes. The ROM 22 is a non-volatile storage device that stores in advance information about control programs or the like for causing the CPU 21 to execute various processes. The RAM 23 is a volatile or non-volatile storage device that is used as a temporary storage memory (work area) for various processes which are executed by the CPU 21. The CPU 21 integrally controls the image forming system 100 by executing the various control programs stored in advance in the ROM 22. It is noted that the first control portion 17 may be composed of an electronic circuit such as an integrated circuit (ASIC).

The optional apparatus is connected to the connection portion 18. Specifically, the post-processing apparatus 2 is connected to the connection portion 18 in the image forming system 100. The connection portion 18 is a connector that electrically connects the image forming apparatus 1 and the optional apparatus. The power supply portion 16 supplies power to each of the portions of the optional apparatus connected to the connection portion 18 through the connection portion 18. The first control portion 17 controls the optional apparatus connected to the connection portion 18 through the connection portion 18.

It is noted that the optional apparatus which is connected to the connection portion 18 may be the additional sheet feed unit or the like. In addition, the image forming apparatus 1 may include the plurality of connection portions 18.

### Configuration of Post-processing Apparatus 2

Next, the configuration of the post-processing apparatus 2 will be described with reference to FIG. 1.

The post-processing apparatus 2 is a type of post-processing apparatus called a floor-type post-processing apparatus or a saddle-type post-processing apparatus that is provided adjacent to the image forming apparatus 1 on the installation surface on which the image forming apparatus 1 is installed. It is noted that the post-processing apparatus 2 may be a type of post-processing apparatus called an inner-type post-processing apparatus that is mounted on the sheet discharge tray of the image forming portion 13.

As shown in FIG. 1, the post-processing apparatus 2 includes a second sheet conveyance portion 31, a post-processing portion 32, an input/output IF 33, and a second control portion 34.

The second sheet conveyance portion 31 conveys, to the post-processing portion 32, a sheet conveyed from the image forming apparatus 1. The second sheet conveyance portion 31 includes a second sheet conveyance path and a plurality of second conveyance rollers.

The post-processing portion 32 executes the staple process on a plurality of sheets conveyed from the image forming apparatus 1. The post-processing portion 32 includes a sheet processing tray, a staple portion, a sheet discharge roller pair, and the like.

The input/output IF 33 is an interface that processes an electrical signal which is received from the image forming apparatus 1 and an electrical signal which is output to the image forming apparatus 1. In addition, the input/output IF 33 is supplied with power used to drive each of the portions of the post-processing apparatus 2 from the power supply portion 16 of the image forming apparatus 1 through the connection portion 18.

The second control portion 34 controls the post-processing apparatus 2. As shown in FIG. 1, the second control portion 34 includes a CPU 41, a ROM 42, a RAM 43, and a non-volatile memory 44. The functions of the CPU 41, the ROM 42, and the RAM 43 are the same as the functions of the CPU 21, the ROM 22, and the RAM 23. The non-volatile memory 44 stores information regarding the post-processing apparatus 2 in advance. For example, the non-volatile memory 44 stores option identification information in advance. The option identification information is used to identify the optional apparatus connected to the connection portion 18. It is noted that the second control portion 34 may be composed of an electronic circuit such as an integrated circuit (ASIC).

### Configuration of First Control Portion 17

Next, the configuration of the first control portion 17 will be described with reference to FIG. 1.

As shown in FIG. 1, the first control portion 17 includes a setting processing portion 51 and a switch processing portion 52.

Specifically, the ROM 22 of the first control portion 17 stores an operation control program in advance for causing the CPU 21 to function as each of the processing portions described above. The CPU 21 then functions as each of the processing portions described above by executing the operation control program stored in the ROM 22.

It is noted that the operation control program may be recorded in a computer-readable recording medium such as a CD, a DVD, and a flash memory. The operation control program may be read from the recording medium and stored in a non-volatile storage device provided in the image forming apparatus 1. In addition, some or all of the processing portions included in the first control portion 17 may be each composed of an electronic circuit. In addition, the operation control program may be a program for causing a plurality of processors to function as the respective processing portions included in the first control portion 17.

The setting processing portion 51 sets the function of the optional apparatus (post-processing apparatus 2) connected to the connection portion 18 to be disabled.

For example, the setting processing portion 51 causes the operation display portion 15 to display a setting screen in response to an operation of a user defined in advance on the operation display portion 15. The setting screen receives a setting operation of setting the function of the post-processing apparatus 2 connected to the connection portion 18 to be disabled. The setting processing portion 51 sets the function of the post-processing apparatus 2 connected to the connection portion 18 to be disabled in response to the setting operation.

For example, the setting processing portion 51 prohibits the operation display portion 15 from receiving any operation regarding the post-processing apparatus 2, thereby disabling the function of the post-processing apparatus 2.

It is noted that the setting processing portion 51 may set the function of the post-processing apparatus 2 connected to the connection portion 18 to be automatically disabled in a case where a count value indicating the number of times an abnormality of the post-processing apparatus 2 occurs while a job in which the post-processing apparatus 2 is used is in execution exceeds a value defined in advance.

In addition, the setting processing portion 51 may disable the function of the post-processing apparatus 2 by disconnecting communication with the post-processing apparatus 2. In addition, the setting processing portion 51 may disable the function of the post-processing apparatus 2 by stopping power supply to the post-processing apparatus 2.

Incidentally, the abnormality of the optional apparatus occurs and the abnormality is reported to a user in some cases when the image forming apparatus 1 is started. Here, in a case where the optional apparatus corresponding to the abnormality is the optional apparatus the function of which is disabled, information unnecessary for a user is reported. This causes the user to feel uncomfortable.

In contrast, the image forming apparatus 1 according to the embodiment of this disclosure makes it possible to prevent the abnormality related to the disabled optional apparatus from being reported at the time of the start as described below.

In the case where the abnormality of the optional apparatus connected to the connection portion 18 occurs when the image forming apparatus 1 is started, the switch processing portion 52 switches between reporting the occurrence of the abnormality and not reporting the occurrence of the abnormality on the basis of both whether or not the function of the optional apparatus corresponding to the abnormality is set to be disabled and whether or not the abnormality is a specific abnormality defined in advance.

Specifically, in a case where the function of the optional apparatus corresponding to the abnormality is set to be disabled and the abnormality is not the specific abnormality, the switch processing portion 52 does not report the occurrence of the abnormality.

In contrast, in a case where the function of the optional apparatus corresponding to the abnormality is set to be disabled and the abnormality is the specific abnormality, the switch processing portion 52 reports the occurrence of the abnormality.

In contrast, in a case where the function of the optional apparatus corresponding to the abnormality is not set to be disabled, the switch processing portion 52 reports the occurrence of the abnormality whether or not the abnormality is the specific abnormality.

The specific abnormality is defined in advance by a manufacturer or the like of the image forming apparatus 1. For example, of the abnormalities, the abnormality caused by damage to a member included in the optional apparatus, the abnormality that may cause the optional apparatus to abnormally generate heat, and the like are each defined as the specific abnormality.

Additionally, in a case where the abnormality of the optional apparatus connected to the connection portion 18 occurs when the image forming apparatus 1 is started, the switch processing portion 52 may switch between reporting the occurrence of the abnormality and not reporting the occurrence of the abnormality on the basis of whether or not the function of the optional apparatus corresponding to the abnormality is set to be disabled.

Specifically, in a case where the function of the optional apparatus corresponding to the abnormality is set to be disabled, the switch processing portion 52 does not have to report the occurrence of the abnormality whether or not the abnormality is the specific abnormality.

In contrast, in a case where the function of the optional apparatus corresponding to the abnormality is not set to be disabled, the switch processing portion 52 may report the occurrence of the abnormality whether or not the abnormality is the specific abnormality.

### Report Switching Process

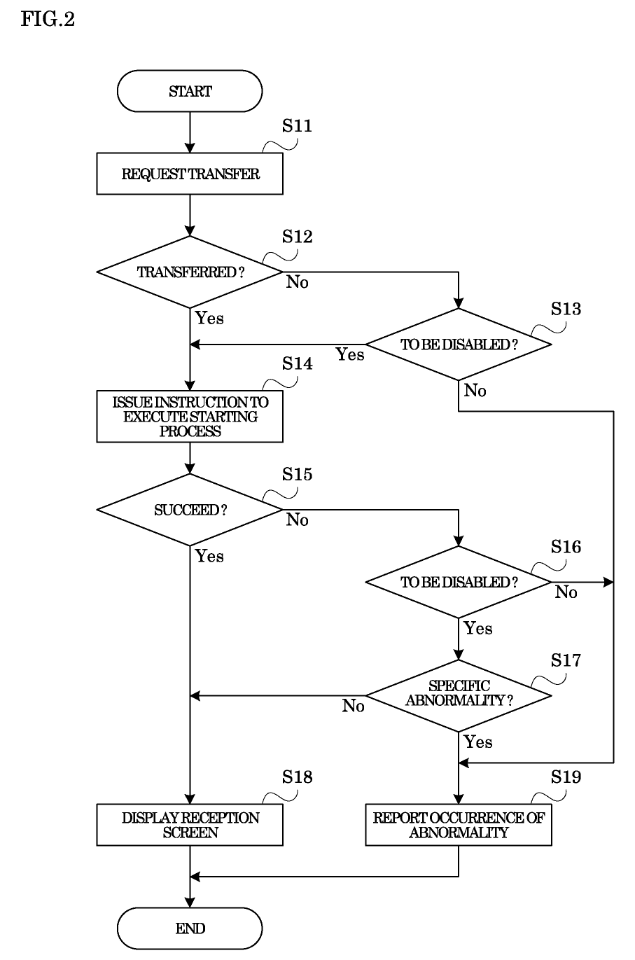

The following describes an operation control method according to this disclosure with reference to FIG. 2 along with examples of procedures of a report switching process that is executed by the first control portion 17 in the image forming apparatus 1. Here, steps S11, S12, ... denote the numbers of processing procedures (steps) that are executed by the first control portion 17.

It is noted that the report switching process is executed when the image forming apparatus 1 is started.

### Step S11

First, in step S11, the first control portion 17 requests the optional apparatus (post-processing apparatus 2) connected to the connection portion 18 to transfer data stored in the non-volatile memory (non-volatile memory 44) of the optional apparatus.

### Step S12

In step S12, the first control portion 17 determines whether or not the optional apparatus (post-processing apparatus 2) connected to the connection portion 18 transfers the data stored in the non-volatile memory (non-volatile memory 44) of the optional apparatus.

Here, when the first control portion 17 determines that the optional apparatus connected to the connection portion 18 transfers the data stored in the non-volatile memory of the optional apparatus (Yes in S12), the first control portion 17 shifts the process to step S14. In this case, the first control portion 17 identifies the optional apparatus connected to the connection portion 18 on the basis of the transferred data. In addition, in a case where the data is not transferred from the optional apparatus connected to the connection portion 18 before a time defined in advance elapses from the time of the execution of the process of step S11 (No in S12), the first control portion 17 determines that data communication with the optional apparatus connected to the connection portion 18 results in failure and shifts the process to step S13.

### Step S13

In step S13, the first control portion 17 determines whether or not the optional apparatus (post-processing apparatus 2) connected to the connection portion 18 is the optional apparatus the function of which is disabled.

Additionally, it is sufficient if the first control portion 17 identifies (estimates) the optional apparatus currently connected to the connection portion 18 on the basis of data transferred from the optional apparatus connected to the connection portion 18 for the last time.

Here, when the first control portion 17 determines that the optional apparatus connected to the connection portion 18 is the optional apparatus the function of which is disabled (Yes in S13), the first control portion 17 shifts the process to step S14. In contrast, if the optional apparatus connected to the connection portion 18 is not the optional apparatus the function of which is disabled (No in S13), the first control portion 17 shifts the process to step S19.

### Step S14

In step S14, the first control portion 17 instructs the optional apparatus (post-processing apparatus 2) connected to the connection portion 18 to execute a starting process.

For example, in the post-processing apparatus 2 that receives the instruction to execute the starting process, the operations of the second sheet conveyance portion 31 and the post-processing portion 32 are confirmed.

### Step S15

In step S15, the first control portion 17 determines whether or not the starting process of the optional apparatus (post-processing apparatus 2) results in success.

Specifically, in a case where the optional apparatus succeeds in the starting process, the optional apparatus notifies the first control portion 17 thereof. In addition, in a case where the abnormality occurs while the starting process is in execution, the optional apparatus notifies the first control portion 17 of an error code indicating the occurrence of the abnormality. The first control portion 17 determines whether or not the starting process results in success on the basis of the notification from the optional apparatus.

Here, when the first control portion 17 determines that the starting process of the optional apparatus results in success (Yes in S15), the first control portion 17 shifts the process to step S18. In contrast, when determining that the starting process of the optional apparatus results in failure (No in S15), the first control portion 17 shifts the process to step S16.

### Step S16

In step S16, the first control portion 17 determines whether or not the optional apparatus (post-processing apparatus 2) connected to the connection portion 18 is the optional apparatus the function of which is disabled.

Here, when the first control portion 17 determines that the optional apparatus connected to the connection portion 18 is the optional apparatus the function of which is disabled (Yes in S16), the first control portion 17 shifts the process to step S17. In contrast, if the optional apparatus connected to the connection portion 18 is not the optional apparatus the function of which is disabled (No in S16), the first control portion 17 shifts the process to step S19.

### Step S17

In step S17, the first control portion 17 determines whether or not the abnormality occurring while the starting process is in execution is the specific abnormality.

Here, when the first control portion 17 determines that the abnormality occurring while the starting process is in execution is the specific abnormality (Yes in S17), the first control portion 17 shifts the process to step S19. In contrast, if the abnormality occurring while the starting process is in execution is not the specific abnormality (No in S17), the first control portion 17 shifts the process to step S18.

### Step S18

In step S18, the first control portion 17 causes the operation display portion 15 to display a reception screen that receives an operation of a user. This allows the user to use the image forming system 100.

### Step S19

In step S19, the first control portion 17 reports the occurrence of the abnormality of the optional apparatus connected to the connection portion 18 when the image forming apparatus 1 is started. Each of the processes of steps S13, S16, S17, and S19 is an example of a switch step according to this disclosure and is executed by the switch processing portion 52 of the first control portion 17.

Specifically, the first control portion 17 causes the operation display portion 15 to display an error screen including a message indicating the occurrence of the abnormality of the optional apparatus connected to the connection portion 18 when the image forming apparatus 1 is started.

In this way, in a case where the abnormality of the optional apparatus connected to the connection portion 18 occurs when the image forming apparatus 1 is started, the image forming apparatus 1 switches between reporting the occurrence of the abnormality and not reporting the occurrence of the abnormality on the basis of whether or not the function of the optional apparatus corresponding to the abnormality is set to be disabled. This makes it possible to prevent the abnormality of the disabled optional apparatus from being reported at the time of the start.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

An image forming apparatus including: a connection portion to which an optional apparatus is connected; a setting processing portion configured to set a function of the optional apparatus connected to the connection portion to be disabled; and a switch processing portion configured to switch, in a case where an abnormality related to the optional apparatus connected to the connection portion occurs when the image forming apparatus is started, between reporting occurrence of the abnormality and not reporting the occurrence of the abnormality on the basis of whether or not the function of the optional apparatus corresponding to the abnormality is set to be disabled.

### Supplementary Note 2

The image forming apparatus according to Supplementary Note 1, in which, in the case where the abnormality related to the optional apparatus connected to the connection portion occurs when the image forming apparatus is started, the switch processing portion switches between reporting the occurrence of the abnormality and not reporting the occurrence of the abnormality on the basis of whether or not the function of the optional apparatus corresponding to the abnormality is set to be disabled and whether or not the abnormality is a specific abnormality defined in advance.

### Supplementary Note 3

The image forming apparatus according to Supplementary Note 1 or 2, in which the setting processing portion sets the function of the optional apparatus connected to the connection portion to be disabled in response to an operation of a user.

### Supplementary Note 4

An operation control method that is executed by an image forming apparatus including a connection portion to which an optional apparatus is connected, the operation control method including: a setting step of setting a function of the optional apparatus connected to the connection portion to be disabled; and a switch step of switching, in a case where an abnormality related to the optional apparatus connected to the connection portion occurs when the image forming apparatus is started, between reporting occurrence of the abnormality and not reporting the occurrence of the abnormality on the basis of whether or not the function of the optional apparatus corresponding to the abnormality is set to be disabled.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a connection portion to which an optional apparatus is connected;
a setting processing portion configured to set a function of the optional apparatus connected to the connection portion to be disabled; and
a switch processing portion configured to switch, in a case where an abnormality related to the optional apparatus connected to the connection portion occurs when the image forming apparatus is started, between reporting occurrence of the abnormality and not reporting the occurrence of the abnormality on a basis of whether or not the function of the optional apparatus corresponding to the abnormality is set to be disabled.

2. The image forming apparatus according to claim 1, wherein, in the case where the abnormality related to the optional apparatus connected to the connection portion occurs when the image forming apparatus is started, the switch processing portion switches between reporting the occurrence of the abnormality and not reporting the occurrence of the abnormality on a basis of whether or not the function of the optional apparatus corresponding to the abnormality is set to be disabled and whether or not the abnormality is a specific abnormality defined in advance.

3. The image forming apparatus according to claim 1, wherein the setting processing portion sets the function of the optional apparatus connected to the connection portion to be disabled in response to an operation of a user.

4. An operation control method that is executed by an image forming apparatus including a connection portion to which an optional apparatus is connected, the operation control method comprising:
a setting step of setting a function of the optional apparatus connected to the connection portion to be disabled; and
a switch step of switching, in a case where an abnormality related to the optional apparatus connected to the connection portion occurs when the image forming apparatus is started, between reporting occurrence of the abnormality and not reporting the occurrence of the abnormality on a basis of whether or not the function of the optional apparatus corresponding to the abnormality is set to be disabled.
